(19) United States
(12) Patent Application Publication
(10) Pub. No.: US 2004/0199730 A1
(43) Pub. Date: Oct. 7, 2004

(54) Device and method for controlling one or more memory modules

(76) Inventors: Georg Erhard Eggers, Munchen (DE); Manfred Proll, Dorfen (DE); Evangelos Stavrou, Munchen (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/809,702

(22) Filed: Mar. 26, 2004

(30) Foreign Application Priority Data
Mar. 26, 2003 (DE) 10313605.3

(51) Int. Cl. G06F 12/00

(52) U.S. Cl. 711/154; 711/105

(57) ABSTRACT

The device according to the invention in each case has a temperature sensor for detecting the temperatures of the memory modules, which is arranged in the memory modules. In addition, a memory control module is provided, which, in order to evaluate the temperatures, is connected to the memory modules via a measurer or means for determining the highest operating temperature of the memory modules. The memory control module is designed and can be operated such that an adaptation operation is initiated, if the highest operating temperature exceeds a specific value.

### CROSS REFERENCE TO RELATED APPLICATIONS

This application claims priority under 35 USC §119(e) to German Application No. 10313605.3, filed on Mar. 26, 2003, and titled “Device and Method for Controlling One or More Memory Modules,” the entire contents of which are hereby incorporated by reference.

### FIELD OF THE INVENTION

The invention relates to a device and a method for controlling one or more memory modules, and more particularly, to the control relating in particular to the operational reliability of the memory module.

### BACKGROUND

Dynamic semiconductor memories have to be refreshed at regular intervals since the stored data are otherwise lost. The frequency with which these refreshes have to be carried out is highly temperature-dependent. Data retention time, i.e., the time duration over which data are retained without a refresh, decreases exponentially as the temperature rises. The data retention time is, therefore, specified for a specific maximum temperature by the memory manufacturer. If the maximum temperature is exceeded during operation, stored data may be lost.

What is critical for the function of the memory module is the temperature of the silicon chip. The temperature cannot be reliably determined by measurement at the housing or in the housing of the system. Although a temperature measurement in the housing of the system, for example, in a PC, supplies first indications, the latter cannot, however, supply the accuracy required for a reliable assessment of the situation. Consequently, for the memory controller of a computer system, which is also referred to as memory control module hereinafter, there has been no possibility of determining whether the memory module or the memory modules have exceeded a critical temperature.

In the worst-case scenario, temperature-dictated errors and crashes occur, therefore, which would have been avoidable through suitable reaction of the system.

The patent specification US 2001/0014049A1 describes a device and a method for regulating the operating temperature of a memory system. The memory system comprises a control unit connected to a plurality of memory modules via a bus system. By a temperature sensor, the operating temperature of each memory module is detected and forwarded to the control unit. If the operating temperature of an individual memory module exceeds a certain threshold value, the control unit alters the operating parameters of the corresponding memory module. As a result, it is possible to operate the memory module in an operating range above a specific threshold value or below a specific threshold value of the temperature.

The possibility of regulating each memory module individually with regard to its operating temperature means that the system proposed works very precisely. However, many control lines are required between the control unit and the memory modules. Furthermore, the computational and control complexity is very high in the case of the regulation proposed.

### SUMMARY

A device and a method for controlling one or more memory modules can make it possible to determine the highest operating temperature of the memory modules and, based on this temperature, to initiate corresponding measures for reducing the highest operating temperature of one or more memory modules, so that system failures or data losses due to the overheating of one or more memory modules can be avoided. The operational reliability can be increased.

The performance of the system can thus be maintained.

A device according to the invention for controlling one or more memory modules can include a memory module with a temperature sensor for detecting the temperature of the memory module, which is arranged in the memory module. The device can also have another memory module with another temperature sensor for detecting the temperature of another memory module, which is arranged in another memory module. The device can include a measurer or a means for determining the highest temperature and a memory control module. The memory control module can be connected to the memory modules via the measurer or means for determining the highest temperature. The memory control module can be designed such that an adaptation operation is initiated if the highest temperature exceeds a specific value.

The temperature can be detected separately for each memory module and each individual memory module can be individually monitored with regard to its operating temperature. Based on the detected temperatures of the individual memory modules, the measurer or means for determining the highest temperature can determine the highest operating temperature of the memory modules present. If the highest temperature exceeds a specific value, the memory control module can initiate an adaptation operation. This can increase the operational reliability of the entire system.

A temperature feedback message has not been provided in standard synchronous dynamic random access memory (SDRAMS) and in double data rate (DDR) memory modules for personal computers (PCs) and workstations.

A method for controlling one or more memory modules can include the following steps. The memory modules can transmit temperature signals to the measurer or means for determining the highest temperature. The measurer or means for determining the highest temperature can communicate the temperature signal corresponding to the highest temperature to the memory control module. The memory control module can evaluate the temperature signal corresponding to the highest temperature and can initiate an adaptation operation, if the temperature of the warmest memory module exceeds a specific value.

In a further embodiment of the device according to the invention, the memory modules can have pulse width coders to generate pulse-width-coded temperature signals, which can be connected upstream of the measurer or means for determining the highest temperature. The measurer or means for determining the highest temperature can include a wired OR circuit to combine the pulse-width-coded temperature signals. The maximum prevailing operating temperature of the memory modules present can be determined simply and with little additional outlay on circuitry.

In one embodiment of the method according to the invention for controlling a memory module, the temperature in the memory module can be lowered, or at least not increased further, by the adaptation operation. This may be done by reducing the number of commands per unit time, which are transmitted to the memory module.

In a further embodiment of the method according to the invention for controlling a memory module, the temperature in the memory module can be lowered by the adaptation operation in that a cooling unit is activated. The operating temperature in the memory module or in the memory modules can be lowered within a short time without performance losses occurring in the computer system.

In an advantageous manner, in the method according to the invention, the number of memory refreshes per unit time can be increased by the adaptation operation. It is thus possible to counteract an undesirable loss of data. With this measure, too, the performance of the computer system is not restricted to a considerable extent.

In the method according to the invention for controlling a memory module, it is possible, moreover, for the memory module to be deactivated in a targeted manner by the adaptation operation. Thus, although less memory space is available to the entire system, the functionality of the system can be maintained.

In order to achieve the object, it is furthermore proposed that, in the method according to the invention, the entire system may also be ramped down in a targeted manner by the adaptation operation. It is thus possible to avoid undesirable system crashes. In addition, the computer system can remain in a stable and defined state throughout the entire time.

According to a further feature of the invention, the temperature may be binary-coded. This means that the temperature signal can readily be evaluated by existing components such as the memory control module, for example, without necessitating an additional conversion of the temperature signal, for example, from analog to digital. If the binary-coded temperature signal supplies the states, “temperature is not critical” or “temperature is critical”, the evaluation in the memory control module can be realized simply and with low outlay.

In one development of the method according to the invention for controlling a memory module, the temperature may be converted into a frequency-coded temperature signal.

According to a further feature according to the invention, the temperature may also be converted into a pulse-width-coded temperature signal.

Finally, in the method according to the invention for controlling a memory module, the temperature may also be converted into an analog temperature signal advantageous, for example, when the temperature sensor integrated in the memory module already supplies an analog measurement signal.

### BRIEF DESCRIPTION OF THE FIGURES

The invention is explained in more detail below using a plurality of exemplary embodiments with reference to three figures.

FIG. 1 shows a first embodiment of the device according to the invention for controlling a memory module,

FIG. 2 shows a second embodiment of the device according to the invention for controlling a plurality of memory modules, and

FIG. 3 shows a timing diagram with a plurality of temperature signals and a resultant output signal.

### DETAILED DESCRIPTION

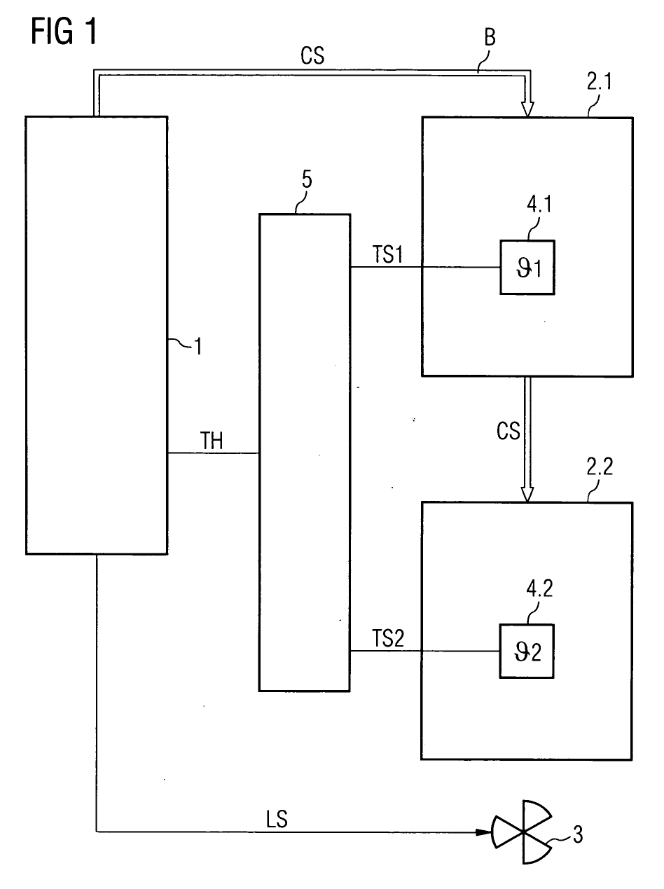

FIG. 1 shows an embodiment of the device for controlling two memory modules 2.1 and 2.2 as a basic illustration. The temperatures ∂1 and ∂2 in the memory modules 2.1 and 2.2 can be detected within the memory modules, in each case, with the aid of a temperature detection unit or a temperature sensor 4.1 and 4.2. The respective temperatures ∂1 and ∂2 can then be converted into respective temperature signals TS1 and TS2 and fed to a measurer or means 5 for determining the highest temperature. The highest operating temperature of one of the memory modules can be fed to a memory controller or memory control module 1 in the form of a temperature signal TH. The latter can evaluate the temperature signal TH and can generate a control signal CS in a manner dependent thereon, which control signal can then be in turn fed to the memory module 2.

As an alternative to this, if appropriate also in addition to this, the memory control module 1 may also generate a fan control signal LS, which can be fed to a fan 3.

The temperature θ of the silicon die of one of the memory modules 2.1 and 2.2 can be measured by a temperature-sensitive semiconductor structure. The result of this measurement can be communicated to the memory controller 1 of the system. In this case, the communication may be effected in binary fashion, for example, as “temperature in the permissible range” or “temperature in the critical range”. As an alternative to this, the temperature ∂ may also be detected and communicated more accurately. The temperature communication may also be effected in analog fashion. If the temperature ∂ is intended to be fed more accurately to the memory control module 1, the temperature ∂ may also be converted with the aid of a frequency or pulse width coding and then communicated.

The memory controller 1 may then react as required by, for example, reducing the number of power-intensive commands per unit time to one of the memory modules 2.1 and 2.2 or both memory modules. It is furthermore possible to reduce the intervals between the refreshes for the memory modules 2.1 and 2.2. Moreover, the fan 3 may be activated, for example, in order to cool the memories. In particular cases, it is also possible for one of the memory modules to be deactivated. Operations can then be carried out only on other memory modules. Finally, it is also possible to ramp down the entire system in controlled fashion.

The electrical energy converted into heat in the memory modules 2.1 and 2.2 can depend on the type and number of commands carried out. By reducing the command load, i.e., the number of commands per unit time, it is thus possible for the memory control module 1 at least to prevent a further heating of the memories 2.1 and 2.2. If the command load cannot be reduced at an elevated temperature, failures by shortening the refresh intervals can be prevented.

In order to preserve compatibility with existing standards for memories, for example, with SDRAM and DDR memory modules, the temperature signals TS1 and TS2 or the temperature signal TH corresponding to the highest operating temperature may be conducted via a non-allocated pin of the housing or of the module connector. It is equally conceivable that the function for outputting the temperature can be activated by a command of the memory control module 1. A mode register set (MRS), in particular, can be appropriate for this purpose.

A protocol which preserves compatibility with previous memory modules can be implemented.

There can be a number of memory modules present on a memory device. As the simplest solution, the memory module situated at what is the relatively warmest position of the printed circuit board (PCB) can be monitored.

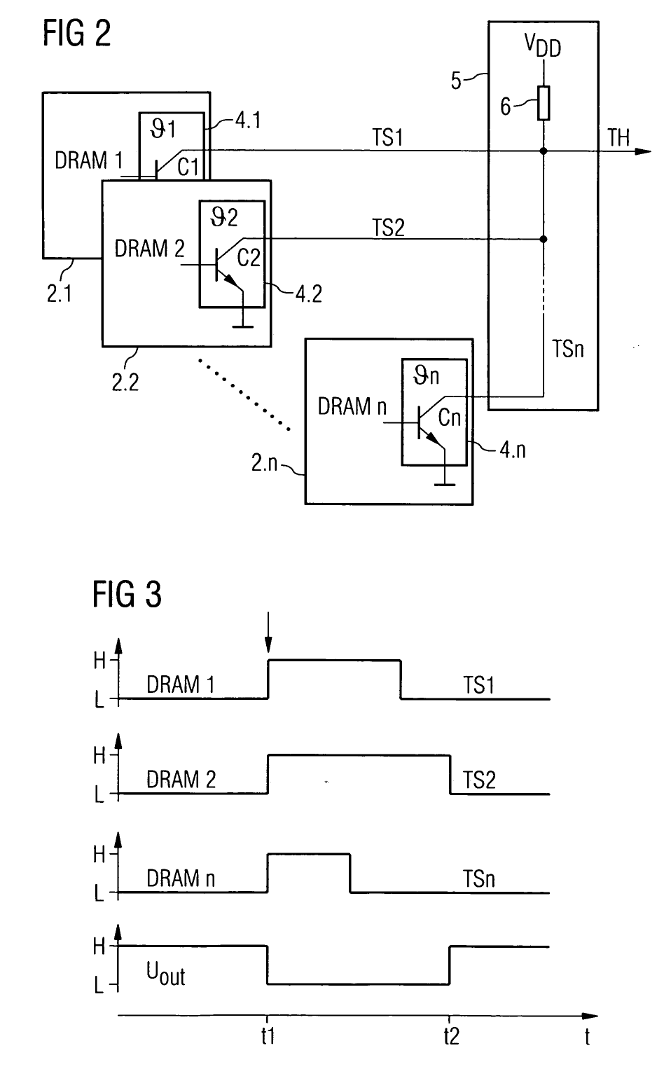

However, since the heating of the memory module may turn out differently due to, for example, unfavorable spatial conditions due to a different type of stored data, monitoring of the memory modules can be enabled. For this purpose, a method, which can communicate the temperature of the warmest memory module, is desirable. Such a device for controlling a plurality of memory modules is illustrated in FIG. 2. The temperature ∂1 in the first memory module 2.1 can be determined with the aid of a temperature sensor 4.1 and can be made available as first temperature signal TS1 at an output of the memory module 2.1. The same applies analogously to the second memory module 2.2. The temperature ∂2 prevailing in the second memory module 2.2 is determined with the aid of a second temperature sensor 4.2 and made available as second temperature signal TS2 at an output of the second memory module 2.2. The same applies, in principle, to the nth memory module 2.n. The temperature ∂n of the nth memory module 2.n can be determined with the aid of an nth temperature sensor 4.n and can be made available as nth temperature signal TSn at an output of the nth memory module 2.n.

As is shown in the timing diagram in FIG. 3, the temperature signals TS1, TS2 to TSn can be present as pulse-width-modulated temperature signals. The corresponding pulse width modulations can be, in each case, detected with the aid of a respective pulse width modulator C1, C2, Cn, which, like the temperature sensors 4.1 to 4.n, can be integrated in the respective memory module 2.1 to 2.n. By a wired OR circuit, the individual temperature signals TS1, TS2 to TSn can be ORed and can be made available as an ORed output voltage TH. The output voltage TH may then be passed to the corresponding control input of the memory control module 1. The individual memory modules 2.1, 2.2 to 2.n can output a low pulse during the temperature communication via an open-collector output. The length of which low pulse can be proportional to the measured temperature ∂1, ∂2 to ∂n. As a result of the outputs at which the respective temperature signal TS1, TS2 to TSn can be tapped off being interconnected with a common pull-up resistor 6, the memory module with the longest pulse, which can correspond to the highest temperature, then can determine the value output. The method of operation is shown in the timing diagram in FIG. 3. At the instant t1, by a trigger event, identified by an arrow, the state of the temperature signals TS1, TS2 to TSn can be read out, which has the effect that the signal Uout can change its logic state at the instant t1. As soon as the last temperature signal, this is the temperature signal TS2 in FIG. 3, can return to the low state again, the output signal Uout can also change its logic state again, which can be effected at the instant t2 in FIG. 3. The time duration t2-t1 can then be a measure of the maximum prevailing temperature.

Since the memory modules 2.1 to 2.n can be controlled via a common memory bus B, the synchronization of the pulse can be output with respect to a defined trigger event can be effected via the memory bus. For example, the instant at which a refresh command (CBR, Refresh) can be triggered may serve as the trigger event.

In principle, a non synchronous output or temperature communication can be possible. The memory control module 1 can draw conclusions about the temperature θ from the statistics of the duty ratio of the voltage on the signal line. The mean value of the voltage generated may be used, for example, for the evaluation.

It is possible, moreover, to calibrate the scaling of the pulse length at the refresh interval required at the present temperature. Shorter refresh intervals then mean longer pulses. The critical value can again be communicated to the memory control module 1 via the wired OR circuit present. The memory control module 1 may then adapt the refresh interval to the temperature conditions. At low temperatures, time may thus be gained for other memory operations by virtue of the saving of time for the refreshing of the memory cells. At high temperatures, data losses may be prevented by the shortening of the refresh intervals.

Referring to FIG. 2, for temperature communication and monitoring, one signal line can be required between the measurer or means for determining the highest temperature 5 and the memory control module 1. By virtue of the fact that the temperature signal of the highest operating temperature of the memory modules present can be fed to the memory control module 1 and the memory control module can initiate the above-described adaptation operations based on knowledge of the highest operating temperature, it is possible to reduce the computational complexity within the memory control module.

The preceding description of the exemplary embodiments in accordance with the present invention serves only for illustrative purposes and not for the purpose of restricting the invention. In the context of the invention, various changes and modifications are possible without parting from the scope of the invention and its equivalents.

### List of Reference Symbols

1 Memory control module

2 Memory module

2.1 First memory module

2.2 Second memory module

2.n nth memory module

3 Fan

4 Temperature sensor

4.1 First temperature sensor

4.2 Second temperature sensor

4.n nth temperature sensor

5 Means for determining the highest temperature

6 Resistor

∂ Temperature

∂1 Temperature in the first memory module

∂2 Temperature in the second memory module

∂n Temperature in the nth memory module

TS Temperature signal

TS1 First temperature signal

TS2 Second temperature signal

TSn nth temperature signal

TH Output signal of the highest operating temperature of a memory module

VDD Operating voltage

C Pulse width modulator

CS Control signal

LS Fan control signal

We claim:

1. A device for controlling one or more memory modules, comprising:
a first memory module with a temperature sensor for detecting the temperature of the first memory module, the temperature sensor being arranged in the first memory module;
a second memory module with a second temperature sensor for detecting the temperature of the second memory module, the second temperature sensor being arranged in the second memory module;
a means for determining a highest temperature; and
a memory control module, the memory control module being connected to the first and second memory modules via the means for determining the highest temperature, the memory control module being designed such that an adaptation operation is initiated, if the highest temperature exceeds a predetermined value.

2. The device as claimed in claim 1, wherein the first and second memory modules having pulse width coders, the pulse width coders generating pulse-width-coded temperature signals, the signals being connected upstream of the means for determining the highest temperature,
the means for determining the highest temperature having a wired OR circuit, the circuit combining the pulse-width-coded temperature signals.

3. A method for controlling one or more memory modules, comprising:
transmitting temperature signals from a first and second memory module to the means for determining a highest temperature;
determining the highest temperature;
communicating the temperature signal corresponding to the highest temperature to a memory control module;
evaluating the temperature signal corresponding to the highest temperature; and
initiating an adaptation operation, if the temperature of the highest memory module exceeds a predetermined value.

4. The method as claimed in claim 3, wherein a number of commands per unit time transmitted to the first and second memory modules is reduced by the adaptation operation.

5. The method as claimed in claim 3, wherein the temperature in the first and second memory modules is lowered by the adaptation operation activating a cooling unit is activated.

6. The method as claimed in claim 3, wherein a number of memory refreshes per unit time is increased by the adaptation operation.

7. The method as claimed in claim 3, wherein one of the memory modules is deactivated in a predetermined manner by the adaptation operation.

8. The method as claimed in claim 3, wherein a system is ramped down in a predetermined manner by the adaptation operation.

9. The method as claimed in claim 3, wherein the temperature is binary-coded.

10. The method as claimed in claim 3, wherein the temperature is converted into a frequency-coded temperature signal.

11. The method as claimed in claim 3, wherein the temperature is converted into a pulse-width-coded temperature signal.

12. The method as claimed in claim 3, wherein the temperature is converted into an analog temperature signal.

13. A device for controlling one or more memory modules, comprising:
a first memory module with a temperature sensor for detecting the temperature of the first memory module, the temperature sensor being arranged in the first memory module;
a second memory module with a second temperature sensor for detecting the temperature of the second memory module, the second temperature sensor being arranged in the second memory module;
a measurer for determining a highest temperature; and
a memory control module, the memory control module being connected to the first and second memory modules via the measurer, the memory control module being designed such that an adaptation operation is initiated, if the highest temperature exceeds a predetermined value.

14. The device as claimed in claim 13, wherein the first and second memory modules having pulse width coders, the pulse width coders generating pulse-width-coded temperature signals, the signals being connected upstream of the measurer, the measurer having a wired OR circuit, the circuit combining the pulse-width-coded temperature signals.

15. A method for controlling one or more memory modules, comprising:
transmitting temperature signals from a first and second memory module to the measurer for determining a highest temperature;
determining the highest temperature;
communicating the temperature signal corresponding to the highest temperature to a memory control module;
evaluating the temperature signal corresponding to the highest temperature; and
initiating an adaptation operation, if the temperature of the highest memory module exceeds a predetermined value.

16. The method as claimed in claim 15, wherein a number of commands per unit time transmitted to the first and second memory modules is reduced by the adaptation operation.

17. The method as claimed in claim 15, wherein the temperature in the first and second memory modules is lowered by the adaptation operation activating a cooling unit is activated.

18. The method as claimed in claim 15, wherein a number of memory refreshes per unit time is increased by the adaptation operation.

19. The method as claimed in claim 15, wherein one of the memory modules is deactivated in a predetermined manner by the adaptation operation.

20. The method as claimed in claim 15, wherein a system is ramped down in a predetermined manner by the adaptation operation.

21. The method as claimed in claim 15, wherein the temperature is binary-coded.

22. The method as claimed in claim 15, wherein the temperature is converted into a frequency-coded temperature signal.

23. The method as claimed in claim 15, wherein the temperature is converted into a pulse-width-coded temperature signal.

24. The method as claimed in claim 15, wherein the temperature is converted into an analog temperature signal.
